(19) United States
(12) Patent Application Publication
(10) Pub. No.: US 2005/0283907 A1
(43) Pub. Date: Dec. 29, 2005

(54) Lifting sling

(76) Inventor: Ian David Dalton, Cheltenham (GB)

Correspondence Address: YOUNG & THOMPSON, 745 SOUTH 23RD STREET, 2ND FLOOR, ARLINGTON, VA, 22202, US

(21) Appl. No.: 10/875,217

(22) Filed: Jun. 25, 2004

(51) Int. Cl. A61G 7/14

(52) U.S. Cl. 5/89.1

(57) ABSTRACT

A lifting sling for use with an invalid hoist, includes a flexible body support, and suspension elements for suspending the sling from an invalid hoist. The flexible body support has at least one inflatable chamber, for cushioning at least a part of an invalid when supported by the body support.

This invention relates to a lifting sling for use with an invalid hoist.

A common complaint with known invalid lifting slings is the discomfort caused to invalids by the hard and cutting binding on the edge of current slings.

The present invention seeks to provide a sling which will give improved comfort to an invalid.

### SUMMARY OF THE INVENTION

According to the present invention, there is provided a lifting sling for use with an invalid hoist, the sling comprising a flexible body support and suspension means for suspending the sling from an invalid hoist, the flexible body support having at least one inflatable chamber for cushioning at least a part of an invalid when supported by the body support.

The invention will now be more particularly described, by way of example, with reference to the accompanying drawings.

### BRIEF DESCRIPTION OF THE DRAWINGS

FIG. 1 is a side perspective view illustrating a conventional one-piece sling and shown in use with a supported invalid.

FIG. 2 is a plan view of one embodiment of a sling according to the present invention,

FIG. 3 is an outside plan view of another embodiment of a sling according to the present invention,

FIG. 4 is an inside plan view of the sling shown in FIG. 3,

FIG. 5 is an outside view of yet another embodiment of a sling according to the present invention,

FIGS. 6a and 6b show inflatable pads for fitting in the pouches of the sling of FIG. 5, and

FIG. 7 is a fragmentary cross sectional view through part of the sling shown in FIG. 5.

### DESCRIPTION OF THE PREFERRED EMBODIMENTS

Referring firstly to FIG. 1 of the drawings, the conventional sling shown therein has a one-piece full body support 1 comprising a body portion 2 with lower end dependent leg support portions 3 and an upper end head support extension 4. The body portion 2 supports the back and shoulders of the suspended invalid I with the portions 3 respectively extending beneath and up between the thighs of the invalid whose head H is supported by the extension 4. Short extension tapes 5 providing suspension means are permanently attached by stitching to the body portion 2 in the shoulder regions thereof, and suspension tapes 6 are similarly attached to the ends of the leg support portions 3.

The body support 1 is manufactured from a sheet of synthetic textile fabric, and it is tailored to conform to the shape of the body of the invalid I.

The sling is illustrated in the drawings as used with a hoist 10 having a cantilever lifting arm 11 supporting a sling hanger 12 of unitary construction and from which the sling 1 is directly suspended. However, it could be used with other types of hoist including ceiling hoists. Only the outer end of the lifting arm 11 is shown, and the hanger 12 is connected to the arm 11 through a pivotal connection 13. The connection is mounted in a bearing 14 providing a vertical pivotal axis A at the end of the arm 11 and it is pivotally connected to the hanger 12 at points 13a.

The hanger 12 is of symmetrical form with spaced arms 15 which respectively pivot on connection 13 and which at their free ends provide a pair of spaced sling attachment points to which the tapes 5 are attached. At the other end the hanger has a central rod 16 terminating in a hand grip 17 and presenting, on opposite sides, a second pair of sling attachment points to which the suspension tapes 6 are attached.

The suspension tapes 5 and 6 are doubled over and pass through respective connecting elements 7 which, as shown, are in the form of key-hole plates that hook onto headed attachment studs 18 providing the respective attachment points on the hanger 12 but which could, for example, be in the form of loop attachments.

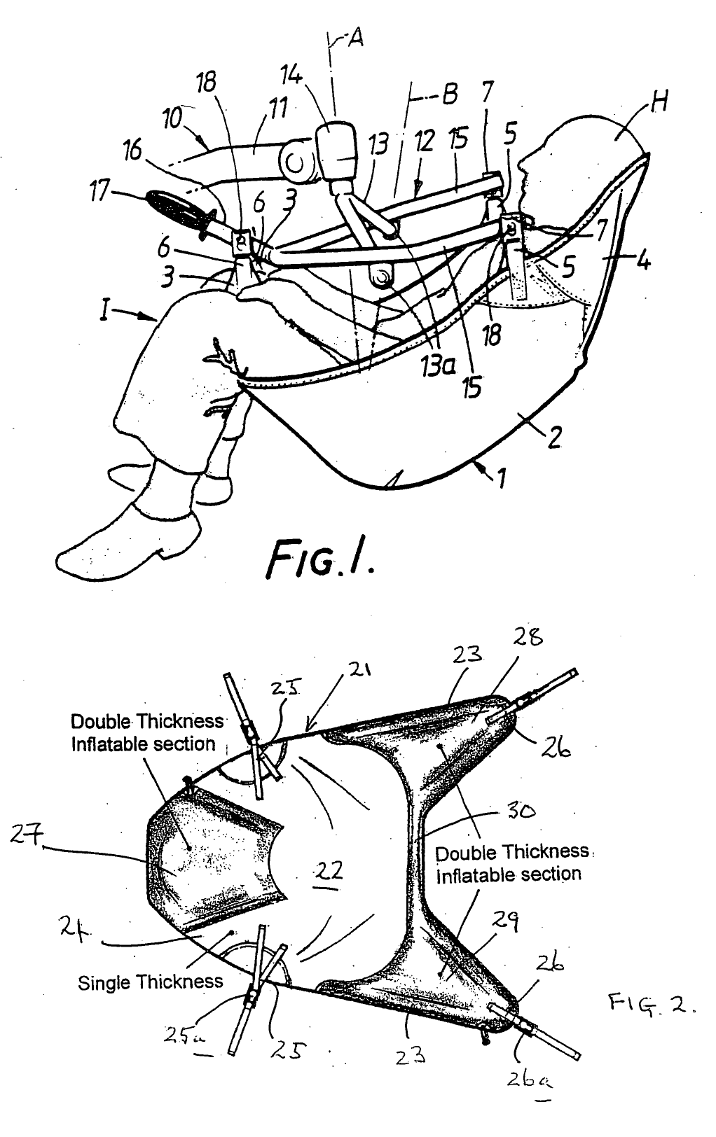

Referring now to FIG. 2 of the drawings, the sling shown therein has a full body support 21 of similar shape to that shown in FIG. 1. The body support 21 has a body portion 22 with lower end dependent leg support portions 23 and an upper end head support extension 24. It also has two suspension tapes 25 attached by stitching to the body portion 22 in the shoulder regions thereof and suspension tapes 26 stitched to the ends of the leg support portions 23. Attachment members in the form of keyhole plates 25a, 26a (or loop attachments) are connected to the suspension tapes 25 and 26.

The sling has an inflatable chamber 27 formed in the upper end head support extension 24 and inflatable chambers 28 and 29 formed in the lower end dependent leg support portions 23. In the embodiment shown, the chambers 28 and 29 are in fluid communication with one another via a narrow chamber 30 extending along the lower edge of the body portion 22.

The body support is made of flexible, air impermeable material, typically Dartex PO97 (C. S. & P.) Types sold by Dartex Coatings Limited, of Nottingham, United Kingdom and the chambers 27, 28, 29 and 30 are formed by double thickness regions of the material secured together using radio frequency induction (RFI) welding, or other suitable bonding means.

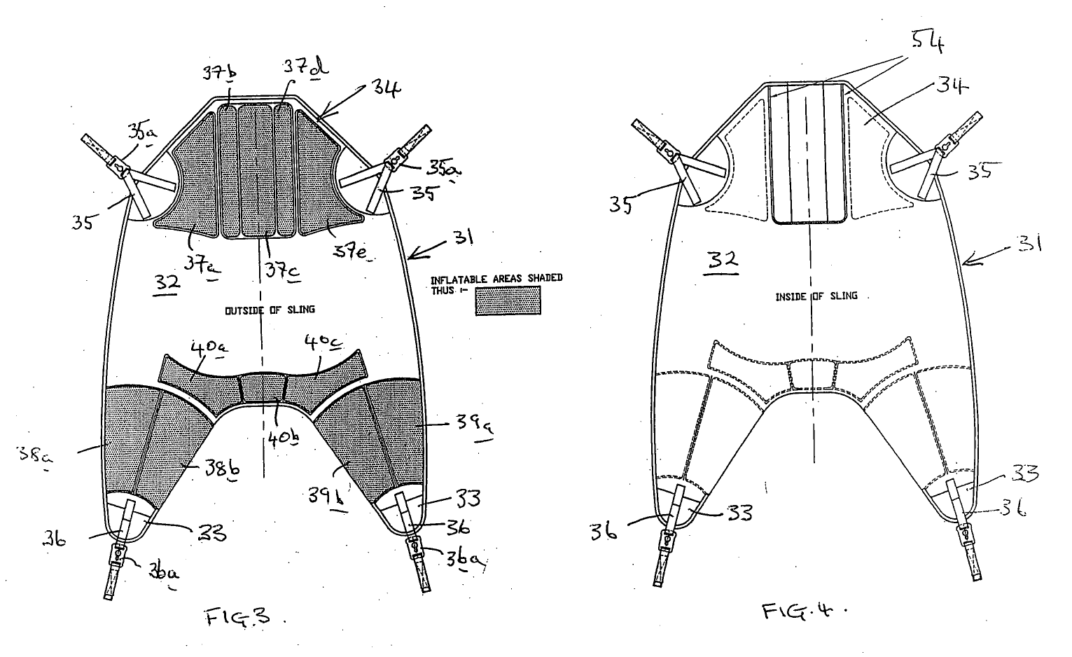

Referring now to FIGS. 3 and 4 of the drawings, the sling shown therein comprises a full body support 31 having a body portion 32 with lower end dependent leg support portions 33 and an upper end head support extension 34. It also has suspension tapes 35 attached to the body portion 32 in the shoulder regions thereof and suspension tapes 36 similarly attached to the ends of the leg support portions 33, each connected to an attachment device in the form of a keyhole plate 35a, 36a. In this embodiment, the upper end head support extension 34 has five separate inflatable chambers 37a, 37b, 37c, 37d and 37e. The dependent leg support portions 33 each have two separate inflatable chambers 38a and 38b, 39a and 39b, respectively, and there are three separate chambers 40a, 40b and 40c in the lower region of the body portion 32.

The body support 31 is again made of flexible air impermeable material, typically Dartex PO97, and the chambers are again formed by double thickness regions of the material secured together using radio frequency induction (RFI) welding, or other suitable bonding means.

Two head support stiffener pockets 54 are sewn or bonded onto the body support 31. These pockets 54 extend substantially throughout the head support extension 34 and for a distance beyond a line joining the attachment points of the upper suspension tapes 45 of the sling. The two pockets 54 are spaced laterally of the sling and each contains a removable strip of resiliently flexible material, typically plastics material such as polypropylene.

Referring now to FIGS. 5 to 7 of the drawings, the sling shown therein again comprises a full body support 41 having a body portion 42, lower end dependent leg support portions 43, an upper end head support extension 44 and suspension tapes 45 and 46 with keyhole attachment members 45a and 46a (or loop attachments).

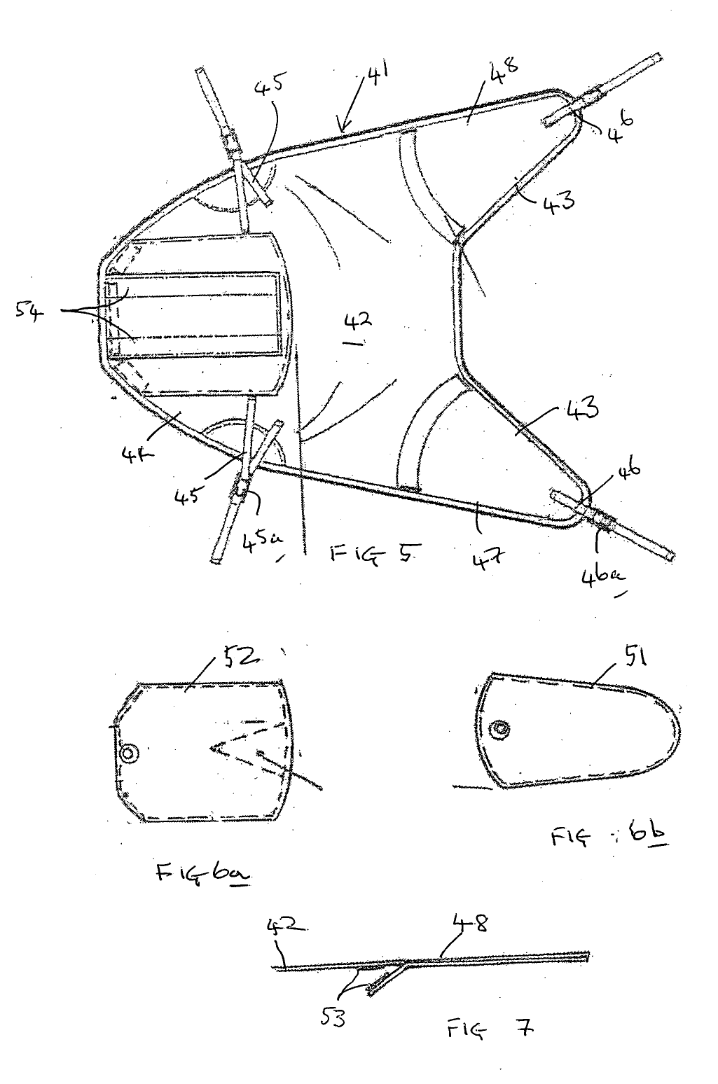

Inflatable pads 51 (FIG. 6b) can be inserted respectively in pouches 47 and 48 in the leg support portions 43 and inflatable pad 52 (FIG. 6a) can be inserted in the pouch 49 in the head support extension 44. These pouches 47, 48 and 49 can then be releasably closed by loop and hook fastening means 53 shown in FIG. 7.

Two head support stiffener pockets 54 are sewn or bonded onto the pouch material. These pockets 54 extend substantially throughout the head support extension 44 and for a distance beyond a line joining the attachment points of the upper suspension tapes 45 of the sling. The two pockets 54 are spaced laterally of the sling and each contains a removable strip of resiliently flexible material, typically plastics material such as polypropylene.

This body support 41 can be manufactured from a flexible sheet of synthetic textile fabric and is in that regard similar to the conventional sling shown in FIG. 1. The inflatable pads can be removed if desired to enable the sling to be used in conventional manner and they can also be removed, if required, when the invalid has been lifted into a position in which he/she will remain for some considerable time.

The body supports of the slings described above are flexible, allowing accommodation of persons of varying sizes and dimensions.

The inflatable chambers of the embodiments described above provide improved comfort particularly where an invalid has special lifting requirements, suffers from brittle bone, delicate skin or physical shape problems or has specific medical requirements.

The inflatable chambers could also be subject to air rippling with the use of a small air pump in order to minimise the risk of pressure sores/pressure ulcers.

The slings described above are full body support slings but the invention is equally applicable to other types of slings including toileting slings which include a relatively narrow body portion and two dependent leg portions and also to slings which are used with standing aids and which pass around the back of a patient and beneath the arms to lift a patient from a seated to a standing position.

The embodiments described above are given by way of example only and various modifications will be apparent to persons skilled in the art without departing from the scope of the invention as defined by the appended claims. For example, the removable inflatable chambers could be held to the body support simply via heads and loop fastening means.

1. A lifting sling for use with an invalid hoist, the sling comprising a flexible body support and suspension means for suspending the sling from an invalid hoist, the flexible body support having at least one inflatable chamber for cushioning at least a part of an invalid when supported by the body support, wherein the body support comprises a body portion and lower end dependent leg portions which in use respectively extend beneath and upwardly between the thighs of the invalid, and wherein each dependent leg portion has at least one inflatable chamber.

2. A lifting sling as claimed in claim 1, wherein the suspension means comprise short suspension tapes permanently attached to the body support and connected to attachment members adapted to hook onto the attachment points on the hoist.

3. A lifting sling as claimed in claim 2, wherein the attachment members comprise keyhole plates adapted to hook onto headed attachment studs providing said attachment points.

4-5. (canceled)

6. A lifting sling as claimed in claim 1, wherein the body portion also includes at least one inflatable chamber.

7. A lifting sling for use with an invalid hoist, the sling comprising a flexible body support and suspension means for suspending the sling from an invalid hoist, the flexible body support having at least one inflatable chamber for cushioning at least a part of an invalid when supported by the body support, and an upper end head-support extension including at least one inflatable chamber, wherein the body support comprises a body portion and lower end dependent leg portions which in use respectively extend beneath and upwardly between the thighs of the invalid.

8. A lifting sling as claimed in claim 7, wherein the sling has at least one pocket extending substantially throughout the head support extension and for a distance beyond a line joining attachment points of upper suspension means of the sling and a removable sheet or strip of substantially rigid but resiliently flexible material is housed in the at least one pocket.

9. A lifting sling as claimed in claim 8, wherein the substantially rigid but resiliently flexible material is a plastics material.

10. A lifting sling as claimed in claim 1, wherein the at least one inflatable chamber is an integral part of the sling.

11. A lifting sling as claimed in claim 1, wherein the at least one inflatable chamber is formed by an inflatable pad removably housed in a pouch of the body support.

12. A lifting sling as claimed in claim 11, wherein the pouch is releasably closable by hook and loop fastening means.

13. A lifting sling for use with an invalid hoist, the sling comprising a flexible body support and suspension means for suspending the sling from an invalid hoist, the flexible body support having at least one inflatable chamber for cushioning at least a part of an invalid when supported by the body support, wherein the suspension means comprise short suspension tapes permanently attached to the body support and connected to attachment members adapted to hook onto the attachment points on the hoist, and wherein the attachment members comprise keyhole plates adapted to hook onto headed attachment studs providing said attachment points.
